(19) United States
(12) Patent Application Publication
(10) Pub. No.: US 2015/0143342 A1
(43) Pub. Date: May 21, 2015

(54) FUNCTIONAL VALIDATION OF SOFTWARE

(71) Applicant: Microsoft Corporation, Redmond, WA (US)

(72) Inventors: Dinesh B. Chandnani, Sammamish, WA (US); Erfan Ghazi Nezami, Bothell, WA (US); Ritesh R. Parikh, Redmond, WA (US)

(73) Assignee: Microsoft Corporation, Redmond, WA (US)

(21) Appl. No.: 14/081,860

(22) Filed: Nov. 15, 2013

(51) Int. Cl. G06F 11/36

(52) U.S. Cl. CPC G06F 11/3616
USPC 717/126; 717/130

(57) ABSTRACT

Aspects of the subject matter described herein relate to software validation. In aspects, a baseline may be created by instrumenting code of a software application or runtime, executing the code of the software application a plurality of times to generate a plurality of logs, determining invariant characteristics of the logs, and writing the invariant characteristics to a baseline. When a new version of the software application or runtime is created, the new version may be validated by instrumenting the code of the new version or runtime, executing the code of the new version, and comparing the log generated with the baseline.

### BACKGROUND

Testing a software application through successive versions can be a tedious and time consuming. For example, in one approach, when a new version of a software application is created, human software testers may perform an array of tests to determine whether the new version functions correctly. Each time a new version is released, the human software testers may again perform the tests to verify correctness of the new version.

In some software test environments, software testers may write automated software testing modules. When a new version of a software application is created, in some cases, the modules may be able to be executed without modification. In other cases, they may need to be modified to work with the new version. In any case, this method of testing may involve substantial time to create and update the testing modules and may provide limited coverage in the testing of the software application.

The subject matter claimed herein is not limited to embodiments that solve any disadvantages or that operate only in environments such as those described above. Rather, this background is only provided to illustrate one exemplary technology area where some embodiments described herein may be practiced.

### SUMMARY

Briefly, aspects of the subject matter described herein relate to software validation. In aspects, a baseline may be created by instrumenting code of a software application or runtime, executing the code of the software application a plurality of times to generate a plurality of logs, determining invariant characteristics of the logs, and writing the invariant characteristics to a baseline. When a new version of the software application or runtime is created, the new version may be validated by instrumenting the code of the new version or runtime, executing the code of the new version, and comparing the log generated with the baseline.

This Summary is provided to briefly identify some aspects of the subject matter that is further described below in the Detailed Description. This Summary is not intended to identify key or essential features of the claimed subject matter, nor is it intended to be used to limit the scope of the claimed subject matter.

The phrase “subject matter described herein” refers to subject matter described in the Detailed Description unless the context clearly indicates otherwise. The term “aspects” should be read as “at least one aspect.” Identifying aspects of the subject matter described in the Detailed Description is not intended to identify key or essential features of the claimed subject matter.

The aspects described above and other aspects of the subject matter described herein are illustrated by way of example and not limited in the accompanying figures in which like reference numerals indicate similar elements and in which:

### BRIEF DESCRIPTION OF THE DRAWINGS

FIG. 1 is a block diagram representing an exemplary computing environment into which aspects of the subject matter described herein may be incorporated;

FIG. 2 is a block diagram that generally represents exemplary components of a system configured in accordance with aspects of the subject matter described herein; and

FIGS. 3-4 represent examples of different invariant characteristics in accordance with aspects of the subject matter described herein; and

FIGS. 5-6 are flow diagrams that generally represent exemplary actions that may occur in accordance with aspects of the subject matter described herein.

### DETAILED DESCRIPTION

### Definitions

As used herein, the term “includes” and its variants are to be read as open-ended terms that mean “includes, but is not limited to.” The term “or” is to be read as “and/or” unless the context clearly dictates otherwise. The term “based on” is to be read as “based at least in part on.” The terms “one embodiment” and “an embodiment” are to be read as “at least one embodiment.” The term “another embodiment” is to be read as “at least one other embodiment.”

As used herein, terms such as “a,” “an,” and “the” are inclusive of one or more of the indicated item or action. In particular, in the claims a reference to an item generally means at least one such item is present and a reference to an action means at least one instance of the action is performed.

Sometimes herein the terms “first”, “second”, “third” and so forth may be used. Without additional context, the use of these terms in the claims is not intended to imply an ordering but is rather used for identification purposes. For example, the phrases “first version” and “second version” do not necessarily mean that the first version is the very first version or was created before the second version or even that the first version is requested or operated on before the second version. Rather, these phrases are used to identify different versions.

The term data is to be read broadly to include anything that may be represented by one or more computer storage elements. Logically, data may be represented as a series of 1's and 0's in volatile or non-volatile memory. In computers that have a non-binary storage medium, data may be represented according to the capabilities of the storage medium. Data may be organized into different types of data structures including simple data types such as numbers, letters, and the like, hierarchical, linked, or other related data types, data structures that include multiple other data structures or simple data types, and the like. Some examples of data include information, program state, program data, other data, and the like.

Headings are for convenience only; information on a given topic may be found outside the section whose heading indicates that topic.

Other definitions, explicit and implicit, may be included below.

### Exemplary Operating Environment

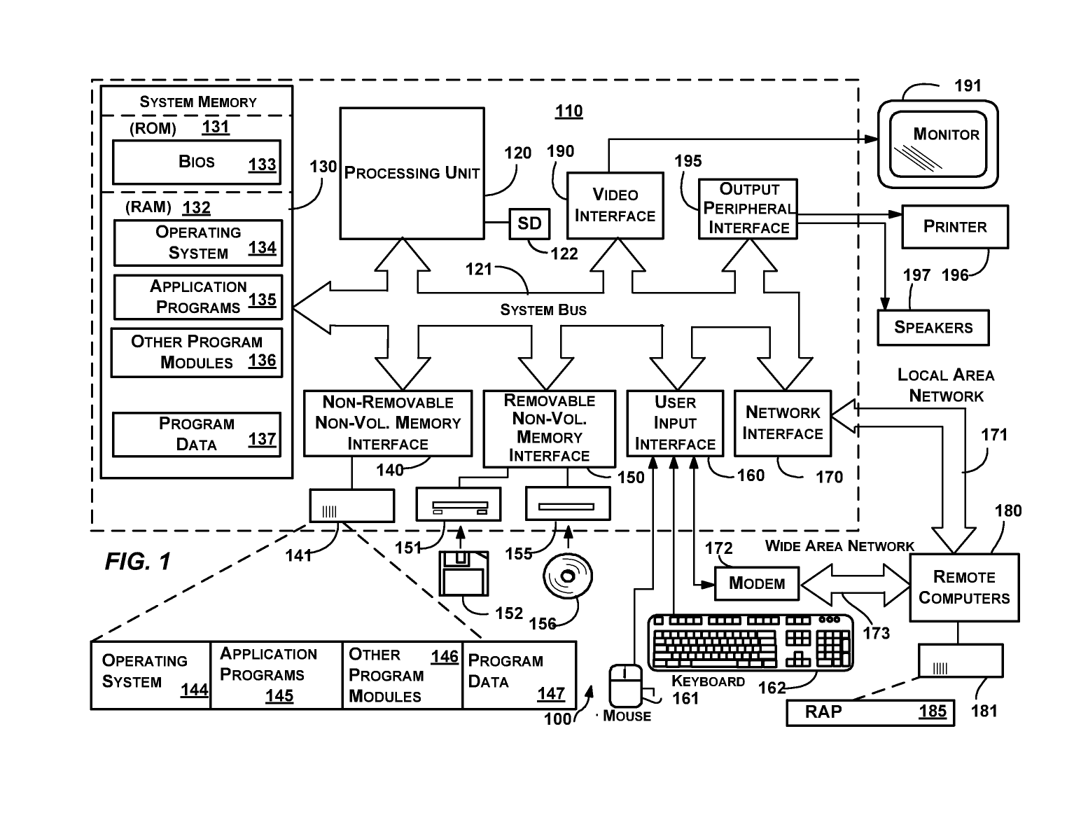

FIG. 1 illustrates an example of a suitable computing system environment 100 on which aspects of the subject matter described herein may be implemented. The computing system environment 100 is only one example of a suitable computing environment and is not intended to suggest any limitation as to the scope of use or functionality of aspects of the subject matter described herein. Neither should the computing environment 100 be interpreted as having any dependency or requirement relating to any one or combination of components illustrated in the exemplary operating environment 100.

Aspects of the subject matter described herein are operational with numerous other general purpose or special purpose computing system environments or configurations. Examples of well-known computing systems, environments, or configurations that may be suitable for use with aspects of the subject matter described herein comprise personal computers, server computers—whether on bare metal or as virtual machines—, hand-held or laptop devices, multiprocessor systems, microcontroller-based systems, set-top boxes, programmable and non-programmable consumer electronics, network PCs, minicomputers, mainframe computers, personal digital assistants (PDAs), gaming devices, printers, appliances including set-top, media center, or other appliances, automobile-embedded or attached computing devices, other mobile devices, phone devices including cell phones, wireless phones, and wired phones, distributed computing environments that include any of the above systems or devices, and the like. While various embodiments may be limited to one or more of the above devices, the term computer is intended to cover the devices above unless otherwise indicated.

Aspects of the subject matter described herein may be described in the general context of computer-executable instructions, such as program modules, being executed by a computer. Generally, program modules include routines, programs, objects, components, data structures, and so forth, which perform particular tasks or implement particular abstract data types. Aspects of the subject matter described herein may also be practiced in distributed computing environments where tasks are performed by remote processing devices that are linked through a communications network. In a distributed computing environment, program modules may be located in both local and remote computer storage media including memory storage devices.

Alternatively, or in addition, the functionality described herein may be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), and the like.

With reference to FIG. 1, an exemplary system for implementing aspects of the subject matter described herein includes a general-purpose computing device in the form of a computer 110. A computer may include any electronic device that is capable of executing an instruction. Components of the computer 110 may include a processing unit 120, a system memory 130, and one or more system buses (represented by system bus 121) that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, Peripheral Component Interconnect (PCI) bus also known as Mezzanine bus, Peripheral Component Interconnect Extended (PCI-X) bus, Advanced Graphics Port (AGP), and PCI express (PCIe).

The processing unit 120 may be connected to a hardware security device 122. The security device 122 may store and be able to generate cryptographic keys that may be used to secure various aspects of the computer 110. In one embodiment, the security device 122 may comprise a Trusted Platform Module (TPM) chip, TPM Security Device, or the like.

The computer 110 typically includes a variety of computer-readable media. Computer-readable media can be any available media that can be accessed by the computer 110 and includes both volatile and nonvolatile media, and removable and non-removable media. By way of example, and not limitation, computer-readable media may comprise computer storage media and communication media.

Computer storage media includes both volatile and nonvolatile, removable and non-removable media implemented in any method or technology for storage of information such as computer-readable instructions, data structures, program modules, or other data. Computer storage media includes RAM, ROM, EEPROM, solid state storage, flash memory or other memory technology, CD-ROM, digital versatile discs (DVDs) or other optical disk storage, magnetic cassettes, magnetic tape, magnetic disk storage or other magnetic storage devices, or any other medium which can be used to store the desired information and which can be accessed by the computer 110. Computer storage media does not include communication media.

Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct wired connection, and wireless media such as acoustic, RF, infrared and other wireless media. Combinations of any of the above should also be included within the scope of computer-readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disc drive 155 that reads from or writes to a removable, nonvolatile optical disc 156 such as a CD ROM, DVD, or other optical media. Other removable/non-removable, volatile/nonvolatile computer storage media that can be used in the exemplary operating environment include magnetic tape cassettes, flash memory cards and other solid state storage devices, digital versatile discs, other optical discs, digital video tape, solid state RAM, solid state ROM, and the like. The hard disk drive 141 may be connected to the system bus 121 through the interface 140, and magnetic disk drive 151 and optical disc drive 155 may be connected to the system bus 121 by an interface for removable nonvolatile memory such as the interface 150.

The drives and their associated computer storage media, discussed above and illustrated in FIG. 1, provide storage of computer-readable instructions, data structures, program modules, and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers herein to illustrate that, at a minimum, they are different copies.

A user may enter commands and information into the computer 110 through input devices such as a keyboard 162 and pointing device 161, commonly referred to as a mouse, trackball, or touch pad. Other input devices (not shown) may include a microphone (e.g., for inputting voice or other audio), joystick, game pad, satellite dish, scanner, a touch-sensitive screen, a writing tablet, a camera (e.g., for inputting gestures or other visual input), or the like. These and other input devices are often connected to the processing unit 120 through a user input interface 160 that is coupled to the system bus, but may be connected by other interface and bus structures, such as a parallel port, game port or a universal serial bus (USB).

Through the use of one or more of the above-identified input devices a Natural User Interface (NUI) may be established. A NUI, may rely on speech recognition, touch and stylus recognition, gesture recognition both on screen and adjacent to the screen, air gestures, head and eye tracking, voice and speech, vision, touch, gestures, machine intelligence, and the like. Some exemplary NUI technology that may be employed to interact with a user include touch sensitive displays, voice and speech recognition, intention and goal understanding, motion gesture detection using depth cameras (such as stereoscopic camera systems, infrared camera systems, RGB camera systems, and combinations thereof), motion gesture detection using accelerometers/gyroscopes, facial recognition, 3D displays, head, eye, and gaze tracking, immersive augmented reality and virtual reality systems, as well as technologies for sensing brain activity using electric field sensing electrodes (EEG and related methods).

A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include phone networks, near field networks, and other networks. Such networking environments are commonplace in offices, enterprise-wide computer networks, intranets, and the Internet.

When used in a LAN networking environment, the computer 110 is connected to the LAN 171 through a network interface or adapter 170. When used in a WAN networking environment, the computer 110 may include a modem 172, network card, or other means for establishing communications over the WAN 173, such as the Internet. The modem 172, which may be internal or external, may be connected to the system bus 121 via the user input interface 160 or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

### Validating Software

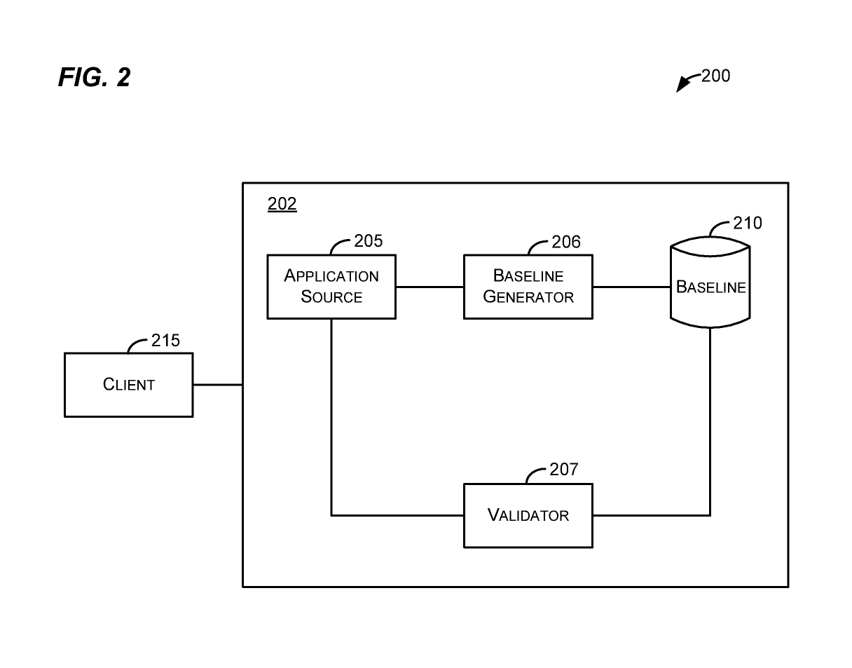

As mentioned previously, testing software can be a tedious and time consuming task. FIG. 2 is a block diagram that generally represents exemplary components of a system configured in accordance with aspects of the subject matter described herein. The components illustrated in FIG. 2 are exemplary and are not meant to be all-inclusive of components that may be needed or included. Furthermore, the number of components may differ in other embodiments without departing from the spirit or scope of aspects of the subject matter described herein. In some embodiments, the components described in conjunction with FIG. 2 may be included in other components (shown or not shown) or placed in subcomponents without departing from the spirit or scope of aspects of the subject matter described herein. In some embodiments, the components and/or functions described in conjunction with FIG. 2 may be distributed across multiple devices.

As used herein, the term component may be read in alternate implementations to include hardware such as all or a portion of a device, a collection of one or more software modules or portions thereof, some combination of one or more software modules or portions thereof and one or more devices or portions thereof, or the like. In one implementation, a component may be implemented by structuring (e.g., programming) a processor (e.g., the processing unit 120 of FIG. 1) to perform one or more actions.

For example, the components illustrated in FIG. 2 may be implemented using one or more computing devices. Such devices may include, for example, personal computers, server computers, hand-held or laptop devices, multiprocessor systems, microcontroller-based systems, set-top boxes, programmable consumer electronics, network PCs, minicomputers, mainframe computers, cell phones, personal digital assistants (PDAs), gaming devices, printers, appliances including set-top, media center, or other appliances, automobile-embedded or attached computing devices, other mobile devices, distributed computing environments that include any of the above systems or devices, and the like.

An exemplary device that may be configured to implement one or more of the components of FIG. 2 comprises the computer 110 of FIG. 1.

In one implementation, a component may also include or be represented by code. Code includes instructions that indicate actions a computer is to take. Code may also include data, resources, variables, definitions, relationships, associations, and the like that include information other than actions the computer is to take. For example, the code may include images, Web pages, HTML, XML, other content, and the like.

Code may be executed by a computer. When code is executed by a computer, this may be called a process. The term “process” and its variants as used herein may include one or more traditional processes, threads, components, libraries, objects that perform tasks, and the like. A process may be implemented in hardware, software, or a combination of hardware and software. In an embodiment, a process is any mechanism, however called, capable of or used in performing an action. A process may be distributed over multiple devices or a single device. Code may execute in user mode, kernel mode, some other mode, a combination of the above, or the like. A service is another name for a process that may be executed on one or more computers.

Furthermore, as used herein, the term “service” may be implemented by one or more physical or virtual entities, one or more processes executing on one or more physical or virtual entities, and the like. Thus, a service may include an actual physical node upon which one or more processes execute, a virtual node upon which one or more processes execute, a group of nodes that work together, and the like. A service may include one or more processes executing on one or more physical or virtual entities. Furthermore, a single process may implement one or more services.

For simplicity in explanation, some of the actions described below are described in a certain sequence. While the sequence may be followed for some implementations, there is no intention to limit other implementations to the particular sequence. Indeed, in some implementations, the actions described herein may be ordered in different ways and may proceed in parallel with each other.

Turning to FIG. 2, the system 200 may include a validation system 202, a client 215, and other components (not shown). The validation system 202 may include an application source 205, a baseline generator 206, a validator 207, a memory 210, and other components. In some implementations, there may be more than one of each of the components listed above.

The application source 205 may include any entity capable of providing a software package. For example, the application source 205 may be implemented on a computer and may include, for example, a file server, an application server, a hard drive or other storage medium, or the like. In one implementation, a software package includes everything that is installed with a software application. In another implementation, a software package may include the code of a software application.

The application source 205 may include a plurality of software packages. For example, in one implementation, the application source 205 may comprise a Web store that hosts a variety of software packages available for download to customers. Each application included in the application source 205 may be identified by one or more identifiers that distinguish the application from other applications and from other versions of the application.

The baseline generator 206 is a component responsible for generating baselines from software packages. A baseline may be generated by executing code from a software package. A baseline may include any data that may be used to determine whether a version of the software package has functionality of the version of the software package used to create the baseline. For example, a baseline may include program state that was outputted to a log during execution of the software package. Examples of program state that may be outputted to a log are described in more detail below.

In addition, a baseline may include sequencing information (e.g., data that indicates an ordering for the records of program state outputted to the log), count information (a count of how many times a particular logging statement output program state), other information, and the like. The sequencing information, count information, and other information included in the baseline may be summarized in the baseline (e.g., as separate records in the baseline or in associated data) or determined by examining the records of the baseline.

In one implementation, a baseline may be created by:

1. Selecting a version of an execution environment (e.g., sometimes referred to as a runtime). Since different runtimes may behave differently when executing the same application, a runtime is needed to use for the baseline.

2. Obtaining a software application from which to create a baseline. A software application may be obtained from the application source 205. Where the application source 205 includes multiple applications, the software application may be selected by requesting a specified application (e.g., by an identifier, index, or the like), by enumerating over the applications, by user input, or the like.

3. Removing variableness from the application prior to executing the application. Some sources of variableness include statements that request the date and applications statements that request a random number. As used herein, a date may include a real time as obtained or maintained by a computer, a counter of a computer that corresponds to real time, a counter of a computer that increases over time but that does not increase proportionate to real time (e.g., each count may correspond to a different length of real time), a day, a month, a year, some combination of the above, or the like. As used herein, a random number may include numbers that are generated starting from a seed, numbers that are generated from random events, some combination of the above, or the like.

To remove variableness of date statements from the application, in one implementation, statements in the application that request a date may be rewritten to obtain a constant date. In another implementation, statements in the application may remain the same but the date function called by the date statements may be rewritten to return a constant date. In another implementation, statements in the application may remain the same but a different date function that returns a constant date may be linked to the application when generating the baseline and when validating version of the application against the baseline. Furthermore, the constant date to use in response to a statement in the application may be captured during an execution of the software application, configured via configuration data, hard-coded in the baseline generator 206, or the like.

To remove variableness from statements that return time elapsed between events, the same approaches described above may be applied to these statements.

To remove variable of statements that request a random number, the same approaches as above may be applied except to statements that use random numbers. For example, in one implementation, a statement in the program that seeds a random number generator may be overwritten with a statement that seeds the random number generator with a constant seed. In another example, each statement that requests a random number may be overwritten to obtain a constant number. In another implementation, the statements in the application that request random numbers may remain changed, but the libraries they call may be overwritten. In yet another implementation, the statements in the application that request random numbers may remain changed, but a different library may be linked to the application that returns non-random numbers.

4. Instrumenting the application or a runtime to log selected information regarding program state during the execution of the application. Often throughout this document, the terminology “instrumenting the application” is used. Whenever this terminology is used, however, it is to be understood that in alternate implementations, the same program state may be obtained by instrumenting the environment (e.g., a runtime) in which the application will be executed.

In addition, the term “function” is sometime used herein. The term “function” as used herein may be thought of as a portion of code that performs one or more tasks. Although a function may include a block of code that returns data, it is not limited to blocks of code that return data. A function may also perform a specific task without returning any data. Furthermore, a function may or may not have input parameters. A function may include a subroutine, a subprogram, a procedure, method, routine, or the like.

Some examples of program state that may be outputted to a log include:

A. The name or other identifier of a function;

B. Values of one or more arguments passed to a function;

C. Values of one or more return values returned from a function;

D. Values of one or more local variables that exist during the execution of the function;

E. Values of one or more global variables available during the execution of the function;

F. If available, one or more names associated with the values mentioned in A-E;

G. A call stack that exists when a logging statement occurs;

H. Caller of the function;

I. A document object model (DOM) tree;

J. Other program state data.

The examples above are not intended to be all-inclusive or exhaustive. Indeed, based on the teachings herein, those skilled in the art may recognize many other program state values that may be logged without departing from the spirit or scope of aspects of the subject matter described herein.

In instrumenting the application to output program state, code may be added to the application to output data at selected locations in the program. For example, code may be added at the beginning, ending, or elsewhere in each function to output one or more of the program state values indicated above. As previously mentioned, similar behavior may also be implemented by instrumenting the runtime instead of the application.

5. Identifying invariant characteristics of the application. Invariant characteristics are those that remain unchanged over a plurality of executions of the application. What is considered to be an invariant characteristics may be defined via configuration data, code, or otherwise. Although configuration data is sometimes discussed herein for defining invariant characteristics, it is to be understood that in other implementations invariant characteristics may be defined by code or otherwise.

For example, if a function is called in each of a set of executions of the application, calling the function may be considered an invariant of the application. If, however, configuration data indicate that the function is to be called first or last or at some other time during the execution of the program, and the function is called but not at the appropriate time, the function may not be considered an invariant of the application.

The ordering in which functions are called may be invariant. For example, if over the course of several executions of a program, function A is called, then function B is called, and then function C is called, the functions called and the ordering in which they are called may considered an invariant characteristic of the application.

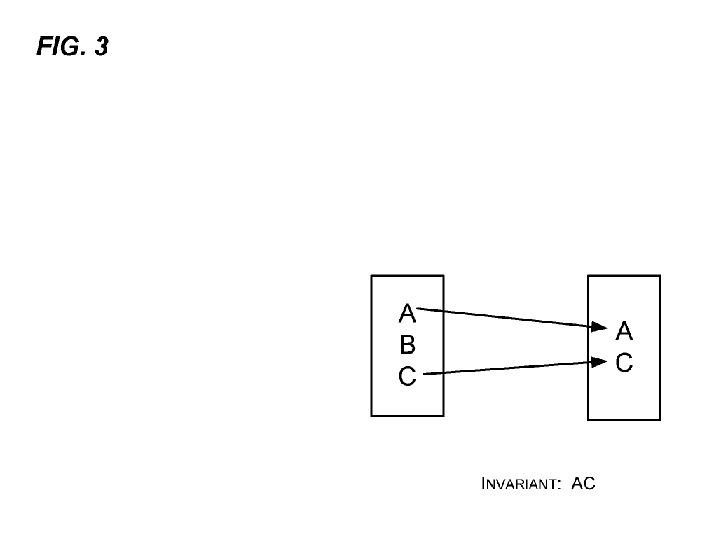

Configuration data, however, may indicate that the ordering matters but that intervening function calls between functions calls do not matter. For example, if over the course of some executions of a program, function A is called, and then function B, and then function C, and if over other executions of the program function A is called and then function C, then configuration data may indicate that having function A called and then later having function C called is invariant even if one or more functions (e.g., function B) are called after A is called and before C is called. An example of this type of matching is illustrated in FIG. 3.

On the other hand, configuration data may indicate that there cannot be any intervening function calls. In this case for the example above, the same calling pattern may be considered not invariant because A is not always followed by B prior to being followed by C.

Furthermore, whether the ordering of function calls matters may also be governed by the nature of the function calls. For example, in a scenario in which navigation through pages of an application occurs, having a new page appear before the new page is requested is an error. That this is an error may be determined by configuration data that indicates that correct ordering is required (at least for these two functions), via determining that this behavior should not occur for this scenario, or otherwise without departing from the spirit or scope of aspects of the subject matter described herein. Similarly, if a function is called asynchronously, this may be used to determine that ordering of function calls is irrelevant.

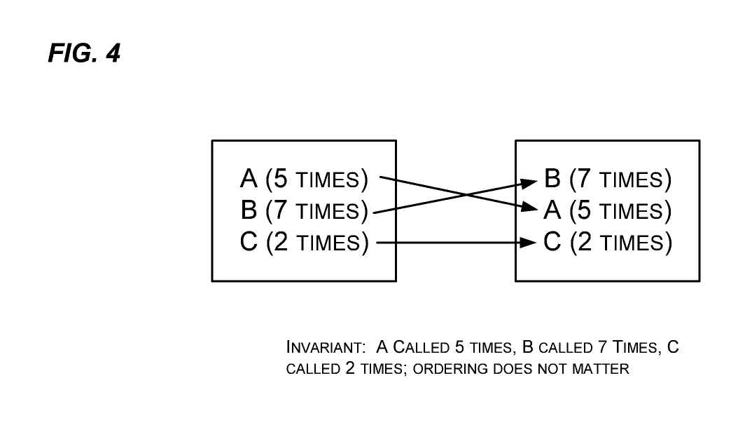

As another example, if a set of functions are called and the number of times that each function is called remains the same, this characteristic may be considered invariant. For example, if function A is called 5 times, function B is called 7 times, and function is C is called 2 times in a one execution of the application and the same functions are called the same number of times in other executions of the application, this may be considered an invariant characteristic of the application. An example of this type of invariance is illustrated in FIG. 4.

If, however, configuration data indicates that the ordering of the calls to A, B, and C matters in addition to the number of times each one is called, then even if A, B, and C are called the appropriate number of times, this may not be considered invariant if the order in which they are called does not accord with the configuration data.

Similarly, any one or more state values written to a log may be used in determining invariant characteristics. For example, with some configuration data, just that the same functions are called may be enough to satisfy an invariant characteristic condition. Other configuration data may require that the same functions be called and that they have one or more call parameters that match across separate executions of the program. Other configuration data may indicate the requirements specified above and may also require that one or more return parameters match across separate executions of the program. Indeed, in various implementations, configuration data may require any permutation of state data, ordering data, and count data to be satisfied in order to determine an invariant characteristic.

In one implementation, invariant characteristics may be determined by performing actions, including:

A. Executing an instrumented application a number of times to generate corresponding logs that include state data corresponding to each execution of the application. The number of times to execute the application during this step may be configurable.

B. Determining the invariant parts of the logs common to all previous executions of the application;

C. Repeating steps A and B above until additional logs do not change the invariant parts.

The invariant parts may then be used to create a baseline. For example, a baseline may indicate that function A is called, followed by function B, followed by function C, and so forth. The baseline may also include other program state data that may be used in validating program execution.

In conjunction with generating a baseline, the baseline generator 206 may store the baseline in the memory 210. The memory 210 may include any storage media capable of storing data. The memory 210 may comprise volatile memory (e.g., RAM), nonvolatile memory (e.g., a hard disk), some combination of the above, and the like and may be distributed across multiple devices. The memory 210 may be external, internal, or include one or more components that are internal and one or more components that are external to computer(s) hosting the validation system 202.

After a baseline is created, it may be used to verify whether a new version of the application or a new version of the runtime produces results that are equivalent to the baseline. This is sometimes referred to as validating the new version of the application or the new version of the runtime. To validate a new version of the application or runtime, the validator 207 may cause the new version of the application or runtime to be instrumented and variableness to be removed from the application (e.g., as described previously). After instrumentation, the validator 207 may cause the application to be executed to generate a log. In conjunction with log generation, the validator 207 may compare the log to the baseline. In comparing the baseline to the log, configuration data or code of the validator 207 may be used to define what variance is allowed and what variance is not allowed between the log and the baseline

In one implementation, if the log of the new version includes the state data that is included in the baseline, the new version is deemed valid. For example, if a baseline includes the functions B and C and the log includes the functions B, D, and C, the new version is deemed valid. With the same example, however, and different configuration data, if the configuration data indicates that there can be no functions in between B and C, then the new version would be deemed invalid.

In an implementation, creating the baseline and validating versions with the baseline may be performed automatically. For example, the baseline generator 206 may periodically scan for new applications in the application source 205. If a new application exists, the baseline generator 206 may generate a baseline and place the baseline in the memory 210.

Similarly, periodically, for each baseline that exists in the memory 210, the validator 207 may check for new versions of applications used to create the baseline, and may then validate the new versions using the baselines. Error reports may be sent to a user of the client 215 via e-mail or some other communication method.

There may be various scenarios that may be automatically tested. For example, in one scenario, the startup (e.g., what does the application do when it is launched) of the application may be tested. In another scenario, the shutdown (e.g., what does the application do when it receives a “close application” event) of the application may be tested.

In another scenario, a test framework may exercise the application in a way that is generated randomly and recorded for testing subsequent versions. For example, to generate a baseline, the application may be launched and random keys might be pressed, random menu items may be selected, random buttons may be pressed, and so forth. To validate a new version, the same events may be replayed and the log generated may be compared to the baseline.

In other implementations, a tester may provide a script (e.g., through some language or via recording UI actions) that defines a scenario. The validation system may then use the script to automatically test certain functionality of the application.

Where code modification is described herein, it is to be understood that in various implementations, the code that is modified may be different. For example, code may be modified in source code, in an intermediate language, in assembly language, binary code, other code derived from the source code, some combination of the above, or the like.

The client 215 may be used to interact with the validation system 202. The client may include an integrated development environment (IDE) or other custom program, a Web browser, or the like. The client 215 may interact with the validation system 202 by:

1. Sending a request to validate code of a new version of a software application (or runtime) to the validation system 202. The validation system 202 may have access to a baseline created as indicated previously.

2. In response to the request, the client 215 may receive data from the validation system 202. The data indicates whether the new version is validated.

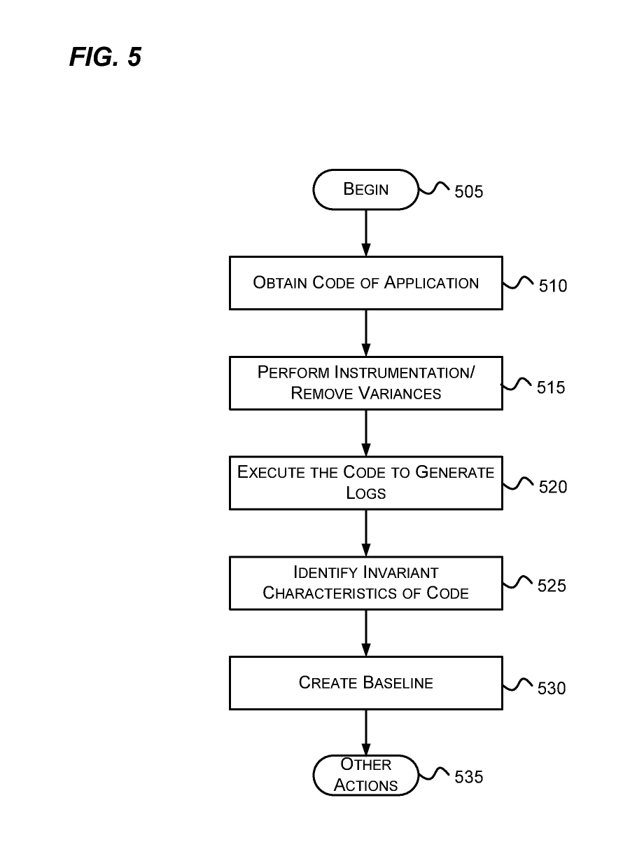

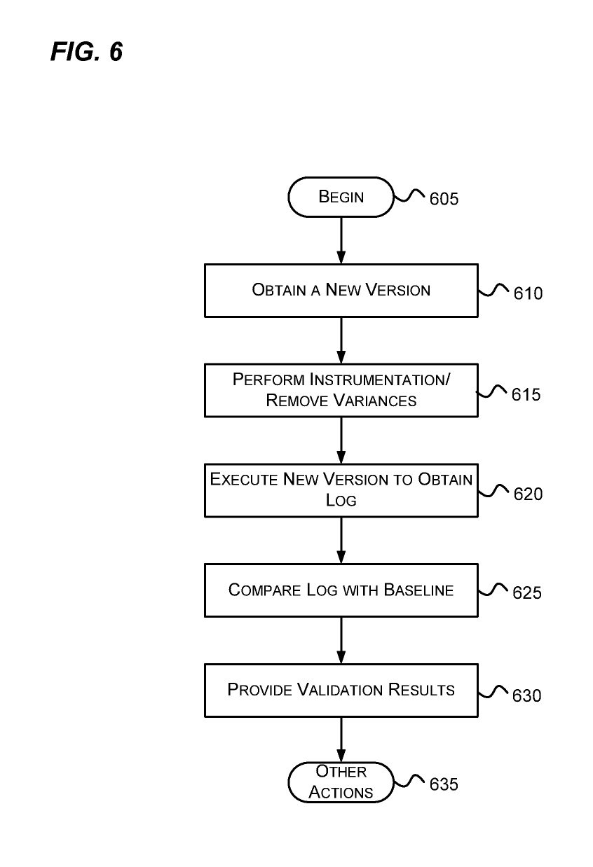

FIGS. 5-6 are flow diagrams that generally represent exemplary actions that may occur in accordance with aspects of the subject matter described herein. For simplicity of explanation, the methodology described in conjunction with FIGS. 5-6 is depicted and described as a series of acts. It is to be understood and appreciated that aspects of the subject matter described herein are not limited by the acts illustrated and/or by the order of acts. In one embodiment, the acts occur in an order as described below. In other embodiments, however, two or more of the acts may occur in parallel or in another order. In other embodiments, one or more of the actions may occur with other acts not presented and described herein. Furthermore, not all illustrated acts may be required to implement the methodology in accordance with aspects of the subject matter described herein. In addition, those skilled in the art will understand and appreciate that the methodology could alternatively be represented as a series of interrelated states via a state diagram or as events.

Turning to FIG. 5, at block 505, the actions begin. At block 510, code of a software package is acquired. For example, referring to FIG. 2, the baseline generator 206 may obtain a software package from the application source 205.

At block 515, instrumentation may be performed so that state information is logged during execution of the code. For example, referring to FIG. 2, the baseline generator 206 may instrument the code or a runtime to log state information during execution of the code. For example, the baseline generator 206 may insert an instrumentation statement in the code of a software application. In addition, variances caused by dates and random numbers may also be removed as described previously.

At block 520, the code is executed a number of times to generate a plurality of logs. For example, referring to FIG. 2, the baseline generator 206 may cause the code to be executed a configurable number of times to generate a plurality of logs. If code of the application is instrumented, when an instrumentation statement of the code is executed, it may write to a log a name of a function that contains the instrumentation statement. If a runtime is instrumented, when the code enter or exits a function, the runtime may write to a log a name of the function.

At block 525, invariant characteristics of the logs are identified. For example, referring to FIG. 2, the baseline generator 206 may determine that functions A, B, and C are called in each log while other functions are not called in each log. As another example, the baseline generator 206 may obtain the names of functions that are called and a number of times the functions are called during each execution of the code.

At block 530, a baseline is created using the invariant characteristics. For example, referring to FIG. 2, the baseline generator 206 may place the names of the functions A, B, and C in the memory 210.

At block 535, other actions, if any, may be performed.

Turning to FIG. 6, at block 605, the actions begin. At block 610, another version of code of the software application (or runtime) is obtained. For example, referring to FIG. 207, the validator 207 may obtain a new version of a software application from the application source 205.

At block 615, instrumentation is performed. For example, referring to FIG. 2, the validator 207 may instrument the new version of the code so that executing the code causes state information to be logged. In addition, variances caused by dates and random numbers may also be removed as described previously.

At block 620, the new version of code is executed to obtain a log. For example, referring to FIG. 2, the validator 207 may cause the new version of code to be executed so that a log is generated.

At block 625, the log is compared with the baseline to validate the new version of the code. For example, referring to FIG. 2, the validator 207 may compare the log generated by executing the new version of code with the baseline. If the log includes the invariant characteristics of the baseline, the new version may be deemed to be valid. Configuration data may be used to determine what is to be compared and in what manner.

For example, validation may include comparing a number of times a function is called in the baseline with a number of times the function is called in the log and indicating that the other version of the software application is validated if the numbers are equivalent. As another example, validation may include comparing a sequence of functions called in the baseline with a sequence of functions called in the log and further comprising indicating that the other version of the software application is validated if the sequences are equivalent. In other implementations or with other configuration data, other examples of validation described herein may also be performed.

At block 630, validation results are provided. For example, referring to FIG. 2, the validator 207 may provide results of the validation to the client 215.

At block 635, other actions, if any, may be performed.

As can be seen from the foregoing detailed description, aspects have been described related to software validation. While aspects of the subject matter described herein are susceptible to various modifications and alternative constructions, certain illustrated embodiments thereof are shown in the drawings and have been described above in detail. It should be understood, however, that there is no intention to limit aspects of the claimed subject matter to the specific forms disclosed, but on the contrary, the intention is to cover all modifications, alternative constructions, and equivalents falling within the spirit and scope of various aspects of the subject matter described herein.

1. A method implemented at least in part by a computer, the method comprising:
selecting a runtime environment;
obtaining code of a software application;
performing instrumentation to log state information during execution of the code;
on the computer, executing the code a number of times using the runtime environment to generate a plurality of logs that include state information obtained from the computer and correspond to each execution of the code using the runtime environment;
identifying invariant characteristics of the logs, the invariant characteristics including a particular function that was called during each execution of the code;
creating a baseline using the invariant characteristics; and
validating the code by comparing the baseline to a log that includes state information obtained from the computer during execution of the code using a different runtime environment.

2. The method of claim 1, wherein performing instrumentation to log state information during execution of the code comprises inserting an instrumentation statement in the code of the software application.

3. The method of claim 2, wherein executing the code executes the instrumentation statement that writes to a log a name of a function that contains the instrumentation statement.

4. The method of claim 2, wherein executing the code executes the instrumentation statement that writes to a log values of arguments passed to a function containing the instrumentation statement.

5. The method of claim 2, wherein executing the code executes the instrumentation statement that writes to a log values of variables, the values existing when the instrumentation statement executes.

6. The method of claim 2, wherein inserting an instrumentation statement in the code of the software application comprises inserting the instrumentation statement in source code of the software application.

7. The method of claim 2, wherein inserting an instrumentation statement in the code of the software application comprises inserting the instrumentation statement in code derived from source code of the software application.

8. The method of claim 1, wherein performing instrumentation to log state information during execution of the code comprises instrumenting the runtime environment to log the state information in conjunction with executing the code of the software application.

9. The method of claim 1, further comprising removing variableness from the code prior to executing the code by modifying a date statement in the code to use a specified date value during each execution of the code.

10. The method of claim 1, further comprising removing variableness from the code prior to executing the code by modifying a random number statement to use a specified seed and using the specified seed for random number generation during each execution of the code.

11. The method of claim 1, wherein identifying invariant characteristics of the logs comprises obtaining a name of a function and a number of times the function is called during a single execution of the code.

12. The method of claim 1, further comprising:
obtaining another version of code of the software application;
instrumenting the other version of code to log state information during execution of the other version of code;
executing the other version of code to obtain a log; and
comparing the log with the baseline to validate the other version of code of the software application.

13. The method of claim 12, wherein comparing the log with the baseline comprises comparing a number of times a function is indicated in the baseline with a number of times the function is indicated in the log and further comprising indicating that the other version of the software application is validated if the numbers are equivalent.

14. The method of claim 12, wherein comparing the log with the baseline comprises comparing a sequence of functions indicated in the baseline with a sequence of functions indicated in the log and further comprising indicating that the other version of the software application is validated if the sequences are equivalent.

15. The method of claim 1, wherein creating a baseline using the invariant characteristics comprises including, in the baseline, state information that remains the same throughout the logs and omitting, from the baseline, state information that changes across the logs.

16. In a computing environment, a system, comprising:
a memory structured to store code of a software application and logs generated from executing the code;
one or more processors coupled to the memory, the one or more processors structured to perform actions, the actions comprising:
selecting a runtime environment;
performing instrumentation to log state information obtained during execution of the code;
executing the code a number of times using the runtime environment to generate the logs, the logs including state information corresponding to each execution of the code using the runtime environment;
identifying invariant characteristics of the logs, the invariant characteristics including a particular function that was called during each execution of the code;
creating a baseline using the invariant characteristics; and
validating the code by comparing the baseline to a log that includes state information obtained during execution of the code using a different runtime environment.

17. The system of claim 16, wherein the one or more processors are further structured to perform additional actions, the additional actions comprising:
obtaining another version of code of the software application;
instrumenting the other version of code to log state information during execution of the other version of code;
executing the other version of code to obtain a log;
comparing the log with the baseline to validate the other version of code of the software application.

18. The system of claim 17, wherein the one or more processors being structured to compare the log with the baseline to validate the other version of code of the software application comprises the one or more processors checking whether functions indicated in the baseline are also found in the log without reference to an ordering of the functions.

19. The system of claim 16, wherein the one or more processors being structured to identify invariant characteristics of the logs comprises the one or more processors being structured to obtain configuration data that defines the invariant characteristics.

20. (canceled)

21. A computer storage medium storing computer-executable instructions that, when executed, implement one or more software testing modules configured to:
select a runtime environment;
instrument source code to log state information during execution of the source code;
execute the source code a number of times using the runtime environment to generate logs corresponding to each execution of the source code using the runtime environment;
identify invariant characteristics of the logs, the invariant characteristics including a particular function that was called during each execution of the source code;
create a baseline using the invariant characteristics;
validate the source code by comparing the baseline to a log that corresponds to execution of the source code using a different runtime environment; and
validate a new version of the source code by instrumenting the new version of the source code and comparing the baseline to a log that corresponds to execution of the new version of the source code.
